(19) United States
(12) Patent Application Publication
(10) Pub. No.: US 2019/0210682 A1
(43) Pub. Date: Jul. 11, 2019

(54) ELECTRIC MOTORCYCLE AND HELMET SYSTEM

(71) Applicant: Arkoalo Palchaudhuri, Jalpaiguri (IN)

(72) Inventor: Arkoalo Palchaudhuri, Jalpaiguri (IN)

(21) Appl. No.: 15/905,620

(22) Filed: Feb. 26, 2018

(30) Foreign Application Priority Data
Jan. 11, 2018 (IN) 201731043741

(51) Int. Cl. B62J 99/00; B60R 25/04; B60R 25/23

(52) U.S. Cl. CPC B62J 99/00; B60R 25/04; B62J 2099/004; B62J 2099/0013; B62J 2099/002; B60R 25/23

(57) ABSTRACT

In accordance with one embodiment of the disclosure, an electric motorcycle and helmet system is disclosed. The electric motorcycle and helmet system includes a microcontroller module configured to control a plurality of functions of the electric motorcycle and helmet. The system also includes a sensor module wherein the sensor module further comprises a plurality of sensors operatively coupled to the microcontroller module configured to sense a plurality of parameters. The system includes an operator module communicatively coupled to the microcontroller module configured to store a plurality of data based on the electric motorcycle and helmet. The system also includes a communication module configured to transmit information between the microcontroller module, the sensor module and the operator module via a communication network.

### BACKGROUND

Embodiments of the present disclosure relates to a motorcycle, more particularly to, an electric motorcycle and helmet system.

The pollution level in many countries is on the rise, and such increase in pollution levels only pose environmental threats in the long run. High pollution levels are also considered to be a health hazard, and therefore all measures to reduce pollution levels will be beneficial for societies. Within city limits, vehicles are the cause for majority of the pollution issues; these include 4-wheeled, 3-wheeled and 2-wheeled vehicles. Having vehicles that would produce lower levels of pollution would be beneficial for individuals and the environment.

Most vehicles run on fuel engines where the combustion of the fuel engines produce pollution. As the number of vehicles increase, the pollution rates have also increased. Therefore several measures are being taken to reduce pollution. One such measure includes manufacturing vehicles that run on other forms of energy. Having vehicles run on electric engines would be beneficial for many cities as it would cause lesser pollution. Having alternative systems to run vehicle engines to reduce pollution will be very helpful for environmental and health reasons.

Hence, there is a need for an improved electric motorcycle system to address the aforementioned issues.

### BREIF DESCRIPTION

In accordance with one embodiment of the disclosure, an electric motorcycle and helmet system is disclosed. The electric motorcycle and helmet system includes a microcontroller module configured to control a plurality of functions of the electric motorcycle and helmet. The system also includes a sensor module wherein the sensor module further comprises a plurality of sensors operatively coupled to the microcontroller module configured to sense a plurality of parameters. The system includes an operator module communicatively coupled to the microcontroller module configured to store a plurality of data based on the electric motorcycle and helmet. The system also includes a communication module configured to transmit information between the microcontroller module, the sensor module and the operator module via a communication network.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates a block diagram of an electric motorcycle and helmet system in accordance with an embodiment of the present disclosure;

FIG. 2 illustrates a block diagram of an exemplary embodiment of an electric motorcycle and helmet system in accordance with an embodiment of the present disclosure

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DETAILED DESCRIPTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present disclosure will be described below in detail with reference to the accompanying figures.

Embodiment of the present disclosure relates to an electric motorcycle and helmet system is disclosed. The electric motorcycle and helmet system includes a microcontroller module configured to control a plurality of functions of the electric motorcycle and helmet. The system also includes a sensor module wherein the sensor module further comprises a plurality of sensors operatively coupled to the microcontroller module configured to sense a plurality of parameters. The system includes an operator module communicatively coupled to the microcontroller module configured to store a plurality of data based on the electric motorcycle and helmet. The system also includes a communication module configured to transmit information between the microcontroller module, the sensor module and the operator module via a communication network.

In the following specification and the claims, reference will be made to a number of terms, which shall be defined to have the following meanings. The singular forms “a”, “an”, and “the” include plural references unless the context clearly dictates otherwise.

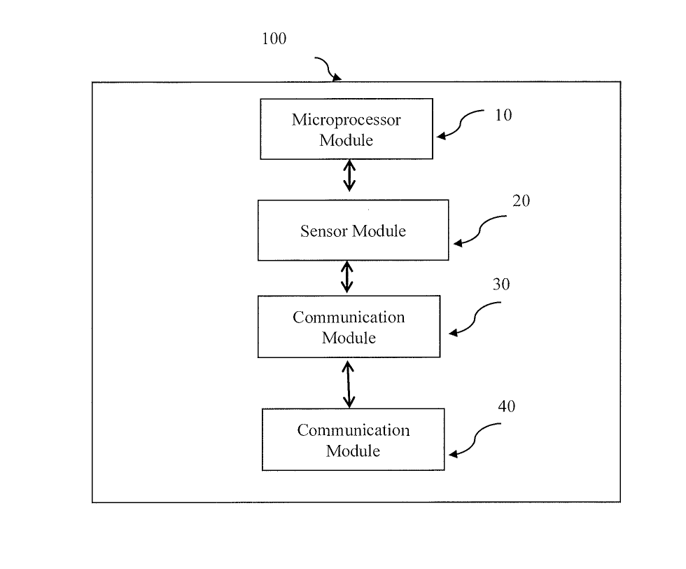

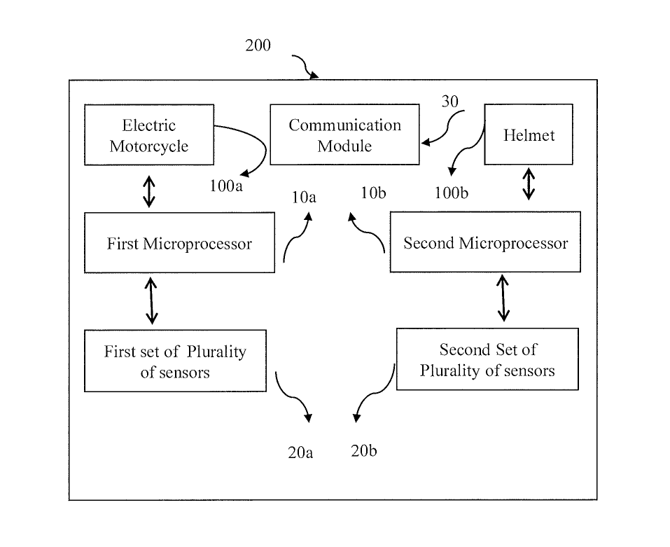

FIG. 1 illustrates a block diagram of an electric motorcycle and helmet system in accordance with an embodiment of the present disclosure. The electric motorcycle and helmet system (100) includes a microcontroller module (10) which is configured to control a plurality of functions of the electric motorcycle and helmet. FIG. 2 illustrates a block diagram of an exemplary embodiment of an electric motorcycle and helmet system in accordance with an embodiment of the present disclosure. The microcontroller module (10) further comprises a first microcontroller (10a) and a second microcontroller (10b), wherein the first microcontroller (10a) is operatively coupled to the electric motorcycle and the second microcontroller (10b) is operatively coupled to the helmet.

According to a further embodiment as illustrated in FIG. 1, the system further includes a sensor module (20) wherein the sensor module (20) further comprises a plurality of sensors operatively coupled to the microcontroller module (10) configured to sense a plurality of parameters. According to FIG. 2, the plurality of sensors further comprises a first set of plurality of sensors (20a) and a second set of plurality of sensors (20b) wherein the first set of plurality of sensors (20a) is operatively coupled to the motorcycle and the second set of plurality of sensors (20b) is operatively coupled to the helmet. According to a further embodiment, the first set of sensors (20a) may include an infrared eye-blink sensor and an alcohol sensor. The second set of sensors (20b) may include an ultrasonic sensor, a proximity sensor, a vibration sensor, a temperature sensor, and a LDR sensor.

According to a further embodiment, the infrared eye-blink sensor present in the helmet gets activated once the rider begins riding the bike. The infrared eye-blink sensor is configured to monitor the eye movement of the rider. If the rider falls asleep while riding, or if there is an abnormal eye-blinking rhythm, the sensor sends a signal to the engine of the electric motorcycle to decelerate and stop.

According to a further embodiment, the ultrasonic sensor and proximity sensor in the electric motorcycle is configured to continuously measure a distance value of the electric motorcycle. For any reason if the electric motorcycle loses control, or if the sensors sense any abnormal distance values, the sensor sends a signal to the engine of the electric motorcycle to decelerate and stop. If any vehicle or object comes in front of the rider, the sensor sends a signal to the electric motorcycle to decelerate, ensuring the rider does not collide with the oncoming object. This will ensure the electric motorcycle does not collide with any other object and provides safety to the rider.

According to a further embodiment, in situation of a collision, the vibration sensor is configured to sense the collision and send an auto generated message to a predetermined contact list through a user device.

According to a further embodiment, the electric motorcycle includes a temperature sensor which is configured to measure the engine motor temperature. If the motor crosses a predefined temperature limit, the sensor sends an indication to the rider to switch off the electric motorcycle in order to cool down the engine.

According to a further embodiment, the electric motorcycle includes an LDR sensor which is configured to control a headlight focus system to automatically change the focus and intensity of light based on the night riding condition of the road. When there is a vehicle approaching from the opposite direction, the LDR helps is allowing the rider to get the optimum view with the right intensity and focus of light.

According to a further embodiment, the alcohol sensor positioned in the helmet is configured to measure the alcohol level of the rider. The alcohol sensor is configured to sense the level of alcohol by detected the vapor of alcohol through the breath of the rider. If the alcohol level of the rider is higher than the predetermined level, the helmet locks the electric motorcycle from being ignited.

According to a further embodiment, the DC motor driver is configured to help in controlling the DC motor.

According to yet another embodiment, the system also includes an operator module (30) communicatively coupled to the microcontroller module configured to store a plurality of data based on the electric motorcycle and helmet. The operator module includes a plurality of data pertaining to both company requirements as well as user requirements. The plurality of data collected and stored by the company and/or user may include vehicle registration data, vehicle specification data, vehicle maintenance data, vehicle troubleshooting data, etc. The company may also have the ability to track and lock the vehicle from a remote location in case of a theft. Once the user informs the company regarding a vehicle theft and provides the company with their unique identification code, the locking procedure can be activated. The plurality of data of the user may also include other aspects such as driving patterns of user, service records, or any other specific details regarding the vehicle.

According to a further embodiment the system further comprises a theft detection module configured to allow a user to lock the engine of a stolen electric motorcycle through the user device

According to a further embodiment, the system also includes a communication module (40) which is configured to transmit information between the microcontroller module, the sensor module and the operator module via a communication network.

According to a preferred embodiment (100), the communication network may be a wireless or wired network, or a combination thereof. Wireless network may include long range wireless radio, wireless personal area network (WPAN), wireless local area network (WLAN), mobile data communication such as 3G, 4G or any other similar technologies. The communication network may be implemented as one of the different types of networks, such as intranet, local area network (LAN), wide area network (WAN), the internet, and the like. The communication network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like. Further the communication network may include a variety of network devices, including routers, bridges, servers, computing devices, storage devices, and the like.

According to a further embodiment, the system further comprises a user device which is communicatively coupled to the microcontroller module. The user device is configured to receive a unique identification code from the microcontroller module in order to start or to stop the motorcycle and helmet system. The user of the electric motorcycle may ignite or stop the engine ignition by using the unique identification code generated through the user device. This procedure may be categorised as an anti-theft feature in the electric motorcycle.

According to a further embodiment of the system, the user interface may include one of a mobile phone, a laptop, a notebook computer, a personal data assistant (PDA) and the like capable of connecting to the Internet and having other communication capabilities. The user interface may communicate through the wireless network/internet or wired connections or a combination thereof. It will be appreciated by those skilled in the art that the user interface includes one or more functional elements capable of communicating through the communication network to request and receive one or more services offered by a general server.

According to a further embodiment, the helmet further comprises a limit switch communicatively coupled to the first microcontroller of the electric motorcycle, configured to control the ignition of the electric motorcycle and helmet system. The limit switch which is placed in the top position inside the helmet is used for limiting the ignition of the engine which ensures the rider wears the helmet while riding the bike. When the rider wears the helmet, the circuit will be closed and the power will be transmitted to the microcontroller module (10). When the rider is not wearing the helmet, the circuit will be open and the power will not be transmitted to the microprocessor module (10). In a scenario where the helmet is worn by the rider, and removed after ignition, the electric motorcycle will automatically stop as there is no connection between the helmet and the electric motorcycle and in other words, there is no connection between the first microcontroller and second microcontroller. By having this type of a limit switch, it encourages the rider to always ride with a helmet, providing more safety for the rider.

According to a further embodiment, the system further includes a power module configured to provide energy to the electric motorcycle and helmet system. The system includes a 12V 1.2 Ah battery pack as an input power to the engine of the electric motorcycle as well as to the microcontroller module.

According to a further embodiment, if there is low or no signal with the communication network the user device is unable to communicate with the microcontrollers, there is a manual mechanism provided to the user, wherein a manual unique identification code is generated by the user for such situations. For this reason, digital meters are used, wherein an inbuilt digital meter or a separate keypad is installed in an electric motorcycle instrumental panel.

According to a further embodiment, the digital meter includes a 4×4 matrix keypad requiring eight Input/ Output ports for interfacing, which is issued as an example. Rows are connected to Peripheral Input/ Output (PIO) pins configured as output. Columns are connected to PIO pins configured as input with interrupts. In this configuration, four pull-up resistors must be added in order to apply a high level on the corresponding input pins. This type of meter includes contact debouncing, easy to interface, interfaces to any microcontroller or microprocessor and data valid output signal for interrupt activation.

According to a further embodiment, matrix keypads use a combination of four rows and four columns to provide button states to the host device, typically a microcontroller. Underneath each key is a pushbutton, with one end connected to one row, and the other end connected to one column. These connections are shown in order for the microcontroller to determine which button is pressed, it first needs to pull each of the four columns (pins 1-4) either low or high one at a time, and then poll the states of the four rows (pins 5-8). Depending on the states of the columns, the microcontroller can tell which button is pressed. For example, say your program pulls all four columns low and then pulls the first row high. It then reads the input states of each column, and reads pin 1 high. This means that a contact has been made between column 4 and row 1, so button ‘A’ has been pressed.

Motorcycles are the most widely chosen vehicles all over the world. The electric motorcycles enrich and provide an exceptional creative mode of the transport system and efficiently solve many problems which people are concerned about. For example, the decreasing levels of natural fuel and increasing the level of pollution are a threat to the environment. Moving towards using environment friendly vehicles is what the younger generation is aiming towards and therefore prefer these electric motorcycles.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim,:

1. An electric motorcycle and helmet system, comprising:
a microcontroller module configured to control a plurality of functions of the electric motorcycle and helmet.
a sensor module wherein the sensor module further comprises a plurality of sensors operatively coupled to the microcontroller module configured to sense a plurality of parameters;
an operator module communicatively coupled to the microcontroller module configured to store a plurality of data based on the electric motorcycle and helmet; and
a communication module configured to transmit information between the microcontroller module, the sensor module and the operator module via a communication network.

2. The electric motorcycle and helmet system as claimed in claim 1, wherein the microcontroller module further comprises a first microcontroller and a second microcontroller, wherein the first microcontroller is operatively coupled to the electric motorcycle and the second microcontroller is operatively coupled to the helmet.

3. The electric motorcycle and helmet system as claimed in claim 1, further comprises a first set of plurality of sensors and a second set of plurality of sensors wherein the first set of plurality of sensors is operatively coupled to the motorcycle and the second set of plurality of sensors operatively is coupled to the helmet.

4. The electric motorcycle and helmet system as claimed in claim 3, wherein the first set of plurality of sensors are atleast one of an infrared eye-blink sensor and an alcohol sensor.

5. The electric motorcycle and helmet system as claimed in claim 3, wherein the second set of plurality of sensors are atleast one of an ultrasonic sensor, a proximity sensor, a vibration sensor, a temperature sensor and a LDR sensor.

6. The electric motorcycle and helmet system as claimed in claim 1, further comprises a user device communicatively coupled to the microcontroller module.

7. The electric motorcycle and helmet system as claimed in claim 6, wherein the user device is configured to receive a unique identification code from the microcontroller module in order to start or to stop the motorcycle and helmet system.

8. The electric motorcycle and helmet system as claimed in claim 1, wherein the helmet further comprises a limit switch communicatively coupled to the first microcontroller of the electric motorcycle, configured to control the ignition of the electric motorcycle and helmet system.

9. The electric motorcycle and helmet system as claimed in claim 1, further comprises a theft detection module configured to allow a user to lock the engine of a stolen electric motorcycle through the user device.

10. The electric motorcycle and helmet system as claimed in claim I, further comprises a power module configured to provide energy to the electric motorcycle and helmet system.
